(19) United States
(12) Patent Application Publication
(10) Pub. No.: US 2025/0117762 A1
(43) Pub. Date: Apr. 10, 2025

(54) INTELLIGENT DOCUMENT FIELD EXTRACTION FROM MULTIPLE IMAGE OBJECTS

(71) Applicant: Capital One Services, LLC, McLean, VA (US)

(72) Inventors: Keegan FRANKLIN, Tucson, AZ (US); James BRIGHTER, Reston, VA (US); Megan OBRIEN, New Orleans, LA (US); John MAILLETT, Arlington, VA (US); Jane JUSTIZ, McLean, VA (US)

(73) Assignee: Capital One Services, LLC, McLean, VA (US)

(21) Appl. No.: 18/503,799

(22) Filed: Nov. 7, 2023

Related U.S. Application Data
(60) Provisional application No. 63/589,233, filed on Oct. 10, 2023.

(51) Int. Cl. G06Q 20/10; G06V 30/41

(52) U.S. Cl. CPC G06Q 20/108; G06Q 20/042; G06V 30/41

(57) ABSTRACT

A computer implemented method, system and non-transitory computer-readable device for a remote deposit environment. Upon receiving a user request, based on interactions with the UI, the method implements an electronic deposit of a financial instrument by activating a camera on the client device to generate a live stream of image data of a field of view of at least one camera, wherein the live stream includes imagery of at least a portion of the financial instrument. The method continues by extracting in real-time, based on the formation of byte array objects from the live stream of image data, data fields from a ranked sequence of imagery to be processed by an optical character recognition (OCR) program resident on the client device. The OCR process extracts one or more data fields from of the financial instrument that are communicated to a remote deposit server to complete the electronic deposit.

### CROSS-REFERENCE TO RELATED APPLICATIONS

This application claims priority to U.S. Provisional Patent Application 63/589,233, titled “Intelligent Document Field Extraction From Multiple Image Objects,” filed Oct. 10, 2023, which is hereby incorporated by reference in its entirety.

### BACKGROUND

As financial technology evolves, banks, credit unions and other financial institutions have found ways to make online banking and digital money management more convenient for users. Mobile banking apps may let you check account balances and transfer money from your mobile device. In addition, a user may deposit paper checks from virtually anywhere using their smartphone or tablet. However, users may have to take pictures and have them processed remotely.

### BRIEF DESCRIPTION OF THE DRAWINGS

The accompanying drawings are incorporated herein and form a part of the specification.

FIG. 1 illustrates an example remote deposit check capture, according to some embodiments and aspects.

FIG. 2 illustrates example remote deposit OCR segmentation, according to some embodiments and aspects.

FIG. 3 illustrates a block diagram of a remote deposit system architecture, according to some embodiments and aspects.

FIG. 4 illustrates an example state diagram of a remote deposit system, according to some embodiments and aspects.

FIG. 5 illustrates an example diagram of a client computing device, according to some embodiments and aspects.

FIG. 6 illustrates a flow diagram for a remote deposit system, according to embodiments and aspects.

FIG. 7 illustrates a block diagram of a ML system, according to some embodiments and aspects.

FIG. 8 illustrates an example computer system useful for implementing various embodiments and aspects.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method, computer program product embodiments, and/or combinations and sub-combinations thereof, for real-time or near real-time multiple-image optical character recognition (OCR) processing on a mobile device or desktop computing device. The disclosed technology may be used to process images of documents during transactions, such as assisting, in real-time or near real-time, a customer to electronically deposit a financial instrument, such as a check. OCR includes the electronic or mechanical conversion of images of typed, handwritten, or printed text into machine-encoded text, whether from a scanned document, a photo of a document, a scene photo, a stream of image data, etc. Using the technology described herein, data (e.g., check amount, signature, MICR line, account number, etc.) may be extracted in real-time or near-real-time from a sequence of images of a check, or portions of the check (e.g., partial check images), without requiring transmission of a captured image of the check, for example, to a remote OCR processing system.

Mobile check deposit is a convenient way to deposit funds using a customer's mobile device or laptop. As technology and digital money management tools continue to evolve, the process has become safer and easier. Mobile check deposit is a way to deposit a financial instrument, e.g., a paper check, through a banking app using a smartphone, tablet, laptop, etc. Currently, mobile deposit allows a customer to capture a picture of a check using, for example, their smartphone or tablet camera and upload it through a mobile banking app running on the mobile device. Deposits commonly include personal, business, or government checks.

Most banks and financial institutions use advanced security features to keep an account safe from fraud during the mobile check deposit workflow. For example, security measures may include encryption and device recognition technology. In addition, remote check deposit apps typically capture check deposit information without storing the check images on the customer's mobile device (e.g., smartphone). Mobile check deposit may also eliminate or reduce typical check fraud as a thief of the check may not be allowed to subsequently make use of an already electronically deposited check, whether it has cleared or not and may provide an alert to the banking institution of a second deposit attempt. In addition, fraud controls may include mobile security alerts, such as mobile security notifications or SMS text alerts, which can assist in uncovering or preventing potentially fraudulent activity.

In existing remote deposit systems and processes, computer-based (e.g., laptop) or mobile-based (e.g., mobile device) technology allows a user to initiate a document uploading process for uploading an image(s) or other electronic versions of a document to a backend system (e.g., a document processing system) for various purposes, including evaluating the quality of the capture image(s). This current process has disadvantages, such as, until remote systems review the quality of the images, the remote deposit processes cannot move forward and, if quality of the image(s) is not acceptable, may require the customer to capture and communicate additional images. This is inefficient and consumes system and network resources that otherwise could be allocated to other tasks. Alternatively, a frustrated user may take their deposit to another financial institution, causing a potential duplicate presentment or fraud issue.

The technology described herein actively processes live camera imagery of a financial instrument located within the camera field of view, allowing, for example, image quality or specific check fields to be evaluated at or around the time of image capture. In one aspect, the live camera imagery is streamed as encoded data configured as a byte array (e.g., as a Byte Array Output Stream object). A byte array is a group of contiguous (side-by-side) bytes, for example, forming a bitmap image. This imagery may be processed continuously, or alternatively, the imagery may be stored temporarily within memory of the mobile device memory, such as, in a frame or video buffer. In existing systems, image capture problems identified at the backend system may be revealed to the customer by cancellations or additional requests from the remote deposit banking system (backend) to recapture images of the check. The technology described herein may reduce or eliminate such drawbacks of existing systems.

Utilizing the disclosed technology, OCR-processed data is communicated to a remote banking processing backend to process the remote deposit. For example, funds availability may be computed to generate a funds availability schedule for a specific deposit and return it to the user's mobile device after the check fields are captured, but before the deposit has been completed. Therefore, implementing the technology disclosed herein, at least a portion of a remote deposit process will be locally processed by a mobile banking app or other image processing app and rendered on a user interface (UI) in real-time or near real-time.

This technical solution eliminates requiring the customer to capture and communicate images without the system first understanding the quality of these images, and thus is more efficient, requires less system and network resources, improves user experience, and may reduce instances of accidental duplicate check presentation. In some embodiments, the technology described herein continuously evaluates a quality of a stream of image data from an activated camera of a mobile device or other customer device. One or more high quality image frames (e.g., entire image of check image), or portions thereof, may be OCR processed to extract data fields locally or, alternatively, in a remote OCR process.

In some embodiments and aspects disclosed herein, the OCR process may be implemented with an active OCR process using a mobile device, instead of after submission of imagery to a backend remote deposit system. However, other known and future OCR applications may be substituted without departing from the scope of the technology disclosed herein.

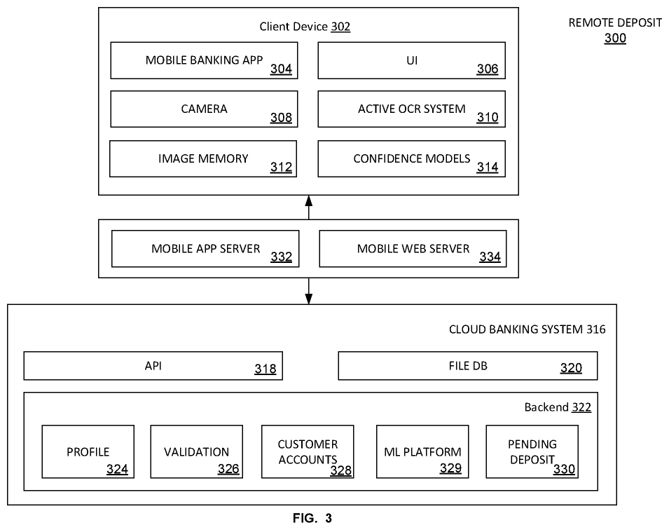

Active OCR is further described in U.S. Provisional Application 63/584,379, entitled “Active OCR,” filed Sep. 21, 2023, and incorporated by reference in its entirety. Active OCR, as further described in FIGS. 3, and 5-7, includes performing OCR processing on image objects formed from a live stream of image data originating from an activated camera on a client device. The image objects may capture portions of a check or an entire image of the check. As a portion of a check image is formed into a byte array, it may be provided to the active OCR system to extract any data fields found within the byte array in real-time or near real-time. In a non-limiting example, if the live streamed image data contains an upper right corner of a check formed in a byte array, the byte array may be processed by the active OCR system to extract the origination date of the check.

In some embodiments, the camera continuously streams image data until all of the data fields have been extracted from the imagery. In some embodiments, various check framing elements, such as a border or corners, assist in alignment of continuously streaming data fields and corresponding Byte Array Output Stream objects. In some embodiments, success of the OCR extraction process may be determined based on reaching an extraction quality threshold. For example, if a trained machine learning (ML) OCR model reaches a determination of 85% surety of a correct data field extraction, then the OCR process for that field may be considered complete. Utilizing this capability, the OCR data is communicated to a banking backend for additional remote deposit processing. Implementing the technology disclosed herein, the deposit may be processed by a mobile banking app and a remote deposit status rendered on a user interface (UI) mid-experience (for example, at or around the time that the user captures an image of the check for remote deposit). Alternatively, or in addition to, portions of the remote deposit sequence may be processed locally on the client device.

Various aspects of this disclosure may be implemented using and/or may be part of remote deposit systems shown in FIGS. 3-5. It is noted, however, that this environment is provided solely for illustrative purposes, and is not limiting. Aspects of this disclosure may be implemented using and/or may be part of environments different from and/or in addition to the remote deposit system, as will be appreciated by persons skilled in the relevant art(s) based on the teachings contained herein. An example of the remote deposit system shall now be described.

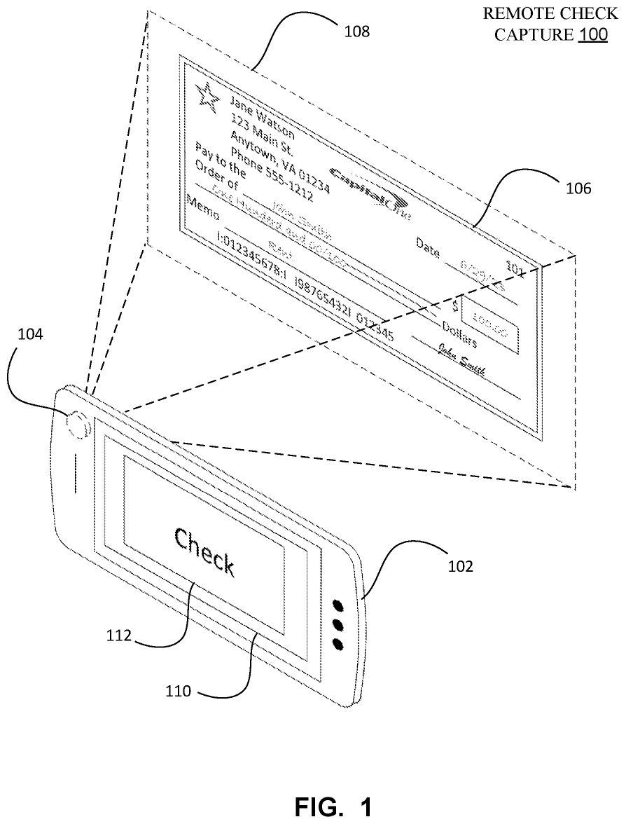

FIG. 1 illustrates an example remote check capture 100, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106, may be a personal check, paycheck, or government check, to name a few. In some embodiments, a customer will initiate a remote deposit check capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer will select a bank account (e.g., checking or savings) into which the funds specified by the check are to be deposited. Content associated with the document include the funds or monetary amount to be deposited to the customer's account, the issuing bank, the routing number, and the account number. Content associated with the customer's account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer will login to their mobile banking app, select the account they want to deposit a check into, then select, for example, a “deposit check” option that will activate their mobile device's camera 104 (e.g., open a camera port). One skilled in the art would understand that variations of this approach or functionally equivalent alternative approaches may be substituted to initiate a mobile deposit.

Using the camera 104 function on the mobile computing device 102, the customer captures live imagery from a field of view 108 that includes at least an image portion 112 of one side of a check 106. Typically, the camera's field of view 108 will include at least the perimeter of the check. However, any camera position that generates in-focus imagery of the various data fields located on a check may be considered. Resolution, distance, alignment, and lighting parameters may require movement of the mobile device until a proper view of a complete check, in-focus, has occurred. An application running on the mobile computer device may offer suggestions or technical assistance to guide a proper framing of a check within the mobile banking app's graphically displayed field of view window 110, displayed on a User Interface (UI) instantiated by the mobile banking app. A person skilled in the art of remote deposit would be aware of common requirements and limitations and would understand that different approaches may be required based on the environment in which the check viewing occurs. For example, poor lighting or reflections may require specific alternative techniques. As such, any known or future viewing or capture techniques are considered to be within the scope of the technology described herein. Alternatively, the camera can be remote to the mobile computing device 102. In an alternative embodiment, the remote deposit is implemented on a desktop computing device with an accompanying digital camera.

Sample customer instructions may include, but are not limited to, “Once you've completed filling out the check information and signed the back, it's time to view your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've viewed a clear image of the front of the check, repeat the process on the back of the check,” “Do you accept the funds availability schedule?,” “Swipe the Slide to Deposit button to submit the deposit,” “Your deposit request may have gone through, but it's still a good idea to hold on to your check for a few days,” “keep the check in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

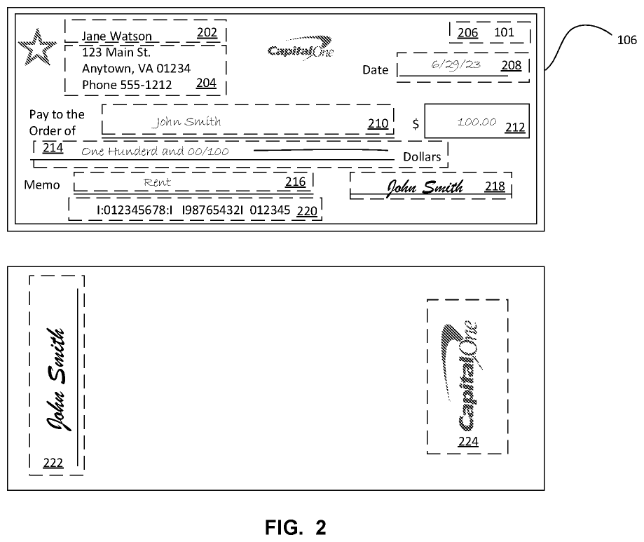

FIG. 2 illustrates example remote deposit OCR segmentation, according to some embodiments and aspects. Depending on check type, a check may have a fixed number of identifiable fields. For example, a standard personal check may have front side fields, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer's account number, and the check number, and finally, the payer customer's signature 218. Back side identifiable fields may include, but are not limited to, payee signature 222 and security fields 224, such as a watermark.

While a number of fields have been described, it is not intended to limit the technology disclosed herein to these specific fields as a check may have more or less identifiable fields than disclosed herein. In addition, security measures may include alternative approaches discoverable on the front side or back side of the check or discoverable by processing of identified information. For example, the remote deposit feature in the mobile banking app running on the mobile device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In one embodiment, active OCR processing of a live stream of check imagery may include implementing instructions resident on the customer's mobile device to process each of the field locations on the check as they are detected or systematically (e.g., as an ordered list extracted from a Byte Array Output Stream object). For example, in some aspects, the streaming check imagery may reflect a pixel scan from left-to-right or from top-to-bottom with data fields identified within a frame of the check as they are streamed. In one non-limiting example, the customer holds their smartphone over a check (or checks) to be deposited remotely while the live stream imagery may be formed into byte array objects (e.g., frames or partial frames), ranked by confidence score (e.g., quality), and top confidence score byte array objects sequentially OCR processed until data from each of required data fields has been extracted.

In another example embodiment, fields that include typed information, such as the MICR line 220, check number 206, payer customer name 202 and address 204, etc., may be OCR processed first from the Byte Array Output Stream objects, followed by a more complex or time intensive OCR process of identifying written fields, which may include handwritten fields, such as the payee field 210, signature 218, to name a few.

In another example embodiment, artificial intelligence (AI), such as machine-learning (ML) systems may train a confidence model (e.g., quality confidence) to recognize quality of a frame or partial frame of image data, or an OCR model(s) to recognize characters, numerals or other check data within the data fields of the streamed imagery. The confidence model and OCR model may be resident on the mobile device and may be integrated with or be separate from a banking application (app). The models may be continuously updated by future images or transactions used to train the model(s).

ML involves computers discovering how they can perform tasks without being explicitly programmed to do so. ML includes, but is not limited to, artificial intelligence, deep learning, fuzzy learning, supervised learning, unsupervised learning, etc. Machine learning algorithms build a model based on sample data, known as “training data,” in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific process to capture relationships between concepts (e.g., image clarity vs. recognition of specific characters or numerals) and a success history. The classifier (discriminator) is trained to distinguish (recognize) variations. Different variations may be classified to ensure no collapse of the classifier and so that variations can be distinguished.

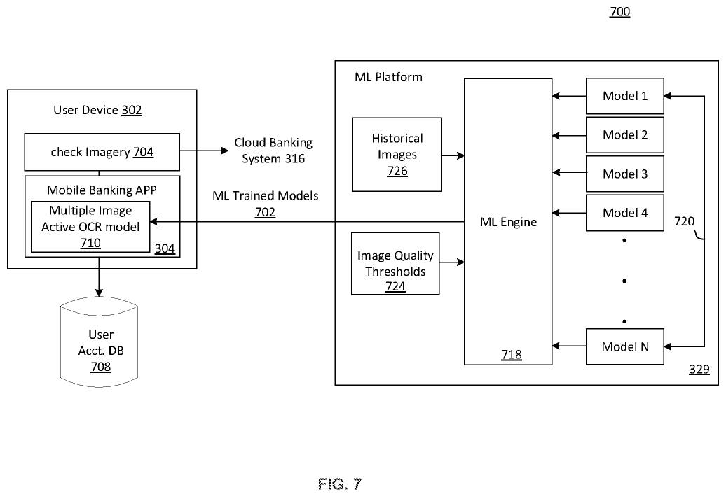

In some aspects, machine learning models are trained on a remote machine learning platform (e.g., see FIG. 3, element 329 and FIG. 7) using other customer's transactional information (e.g., previous remote deposit transactions). In addition, large training sets of the other customer's historical information may be used to normalize prediction data (e.g., not skewed by a single or few occurrences of a data artifact). Thereafter, a predictive model(s) may classify a specific image against the trained predictive model to predict required imagery quality and generate a confidence score or enhance a previously generated OCR query based on provided metadata (resolution, focal length, etc.). In one embodiment, the predictive models are continuously updated as new financial transactions occur.

In some aspects, a ML engine may continuously change weighting of model inputs to increase customer interactions with the remote deposit procedures. For example, weighting of specific data fields may be continuously modified in the model to trend towards greater success, where success is recognized by correct data field extractions or by completed remote deposit transactions. Conversely, input data field weighting that lowers successful interactions may be lowered or eliminated.

FIG. 3 illustrates a remote deposit system architecture 300, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) implements remote deposit processing for one or more financial instruments, such as checks. The client device 302 is configured to communicate with a cloud banking system 316 to complete various phases of a remote deposit as will be discussed in greater detail hereafter.

In aspects, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 is a computer program or software application designed to run on a mobile device such as a phone, tablet, or watch. However, in a desktop application implementation, a mobile banking app equivalent may be configured to run on desktop computers, and web applications, which run in web browsers rather than directly on a mobile device. Apps are broadly classified into three types: native apps, hybrid and web apps. Native applications are designed specifically for a mobile operating system, such as, iOS or Android. Web apps are designed to be accessed through a browser. Hybrid apps may function like web apps disguised in a native container.

Financial instrument imagery may originate from any of, but not limited to, image streams (e.g., series of pixels or frames) or video streams or a combination of any of these or future image formats. A customer using a client device 302, operating a mobile banking app 304 through an interactive UI 306, frames at least a portion of a check (e.g., identifiable fields on front or back of check) with a camera (e.g., field of view).

In one aspect, a confidence scoring process generates a confidence score for each image in a set of images using ML trained confidence models 314. In a first non-limiting example, by first detecting pixels in an image stream, or image byte array, that contain typed or written image components, with, for example, darker, higher contrast, and common black or blue color values, a confidence score may be calculated based on an overall perceived individual image quality. In some aspects, the confidence score may be predicted by a ML model trained on previous images, assigned confidence scores, and corresponding quality ratings. Alternatively, or in addition to, in one aspect, a total pixel score for each image may be calculated. For example, in some aspects, only pixels in a range of pixel values (e.g., range of known marking pixel values, such as 0-50) may be processed, without processing the remaining pixels. For example, those pixels that only include a high pixel value (e.g., lighter pixel grey values), such as, in a background section of the check may not be included in a generated confidence score. In some aspects, pixels that capture preprinted border pixels also may not be considered in the confidence score. In this aspect, the previously discussed ML models may be trained to recognize the values that represent the written or typed information as well as the preprinted borders. For example, using machine learning, thousands or millions of images may be processed to learn to accurately recognize and categorize these pixels.

In one aspect, imagery with a highest confidence score is processed from live stream check imagery from camera 308, as communicated from an activated camera over a period of time, until an active OCR operation has been completed. For example, a highest confidence scored image in a plurality of images, or partial images, is processed by active OCR system 310 to identify as many data fields as possible. Subsequently, the next highest confidence scored image is processed by active OCR system 310 to extract any data fields missing from the first image OCR and so on until all data fields from the check have been captured. Alternatively, or in addition to, specific required data fields (e.g., amount, MICR, etc.) may be identified first in a first OCR of a highest confidence scored image or partial image, followed by subsequent data fields (e.g., signature) in lower confidence scored mages.

In one aspect, the camera imagery is streamed as encoded text, such as a byte array. Alternatively, or in addition to, the live imagery is buffered by storing (e.g., at least temporarily) as images or frames in computer memory. For example, live streamed check imagery from camera 308 is stored locally in image memory 312, such as, but not limited to, a frame buffer, a video buffer, a streaming buffer, or a virtual buffer.

Active OCR system 310, resident on the client device 302, processes the highest confidence images based on live streamed check imagery from camera 308 to extract data by identifying specific data located within known sections of the check to be electronically deposited. In one non-limiting example, single identifiable fields, such as the payer customer name 202, MICR data field 220 identifying customer and bank information (e.g., bank name, bank routing number, customer account number, and check number), date field 208, check amount 212 and written amount 214, and authentication (e.g., payee signature 222) and security fields 224 (e.g., watermark), etc., shown in FIG. 2, are processed by the active OCR system 310.

Active OCR system 310 communicates data extracted from the one or more data fields during the active OCR operation to cloud banking system 316, shown in FIG. 3. For example, the extracted data identified within these fields is communicated to file database (DB) 320 either through a mobile app server 332 or mobile web server 334 depending on the configuration of the client device (e.g., mobile or desktop). In one aspect, the extracted data identified within these fields is communicated through the mobile banking app 304.

Alternatively, or in addition to, a thin client (not shown) resident on the client device 302 processes extracted fields locally with assistance from cloud banking system 316. For example, a processor (e.g., CPU) implements at least a portion of remote deposit functionality using resources stored on a remote server instead of a localized memory. The thin client connects remotely to the server-based computing environment (e.g., cloud banking system 316) where applications, sensitive data, and memory may be stored.

Backend 322, may include one or more system servers processing banking deposit operations in a secure environment. These one or more system servers operate to support client device 302. API 318 is an intermediary software interface between mobile banking app 304, installed on client device 302, and one or more server systems, such as, but not limited to the backend 322, as well as third party servers (not shown). The API 318 is available to be called by mobile clients through a server, such as a mobile edge server (not shown), within cloud banking system 316. File DB stores files received from the client device 302 or generated as a result of processing a remote deposit.

Profile module 324 retrieves customer profiles associated with the customer from a registry after extracting customer data from front or back images of the financial instrument. Customer profiles may be used to determine deposit limits, historical activity, security data, or other customer related data.

Validation module 326 generates a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316 or third party systems or data.

Customer Accounts 328 (consistent with customer's accounts 408) includes, but is not limited to, a customer's banking information, such as individual, joint, or commercial account information, balances, loans, credit cards, account historical data, etc.

ML Platform 329 may generate a trained confidence model or OCR model (e.g., active OCR 310) using a ML engine. This disclosure is not intended to limit the ML Platform 329 to only confidence, active OCR, or OCR model generation, as it may also include, but not be limited to, remote deposit models, risk models, funding models, security models, etc.

When remote deposit status information is generated, it is passed back to the client device 302 through API 318 where it is formatted for communication and display on the client device 302 and may, for example, communicate a funds availability schedule for display or rendering on the customer's device through the mobile banking app UI 306. The UI may instantiate the funds availability schedule as images, graphics, audio, additional content, etc.

Pending deposit 330 includes a profile of a potential upcoming deposit(s) based on an acceptance by the customer through UI 306 of a deposit according to given terms. If the deposit is successful, the flow creates a record for the transaction and this function retrieves a product type associated with the account, retrieves the interactions, and creates a pending check deposit activity.

Alternatively, or in addition to, one or more components of the remote deposit process may be implemented within the client device 302, third party platforms, the cloud-based banking system 316, or distributed across multiple computer-based systems. The UI may instantiate the remote deposit status as images, graphics, audio, additional content, etc. In one technical improvement over current processing systems, the remote deposit status is provided mid-stream, prior to completion of the deposit. In this approach, the customer may terminate the process prior to completion if they are dissatisfied with the remote deposit status.

In one aspect embodiment, remote deposit system 300 tracks customer behavior. For example, did the customer complete a remote deposit operation or did they cancel the request? In some aspects, the completion of the remote deposit operation reflects a successful outcome, while a cancellation reflects a failed outcome. In some aspects, this customer behavior, not limited to success/failure, may be fed back to the ML platform 329 to enhance future training of a remote deposit model. For example, in some embodiments, one or more inputs to the ML remote deposit models may be weighted differently (higher or lower) to effect a predicted higher successful outcome.

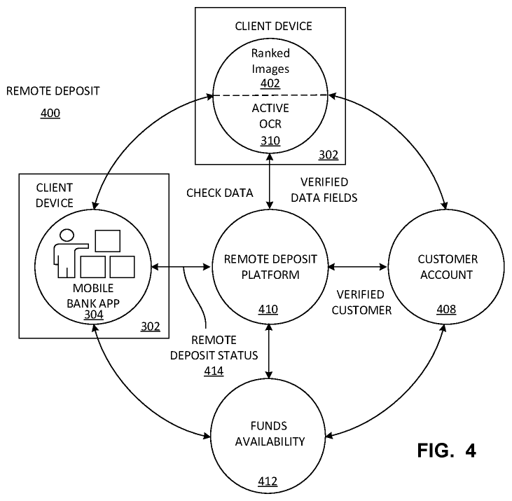

FIG. 4 illustrates an example state diagram of a remote deposit system, according to some embodiments and aspects. The remote deposit 400 system may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one non-limiting example, a customer using a client device 302 (e.g., smartphone 102), operating a mobile banking app 304, frames at least a portion of a check within a field of view of an active camera of client device 302. As previously described, the imagery within the field of view may, in one aspect, be configured as a live stream. In one aspect, the camera imagery is formed into a byte array (e.g., as a Byte Array Output Stream object). The byte array objects are processed by a confidence model to produce a ranked list of byte array objects (e.g., highest confidence to lowest confidence). The ranked list may be sequentially processed (highest to lowest) using an active OCR 310 system or process (e.g., program or ML model) resident on the client device. The active OCR 310 extracts data fields from a plurality of the ranked byte array objects. For example, the active OCR extracts or identifies a check date, check number, payer, payee, amount, payee information, and bank information, to name a few.

While extracting identifiable data from surfaces of the check is a primary output of the active OCR, additional post-processing may be needed to further confirm or verify the data. Additional post active OCR processing may include, but is not limited to, verification of data extracted from the fields based on a comparison with historical customer account data found in the customer's account 408 or the payer's account. The customer account 408, for purposes of description, may be the payee's account, the payer's account or both. For example, a payee's account historical information may be used to calculate a payee's funds availability 412 schedule, while a payer's account may be checked for funds to cover the check amount. Customer account 408 identification, may include single or multiple level login data from mobile banking app 304 to initiate a remote deposit. Alternately, or in addition to, the extracted payee field 210 or the payee signature 222 may be used to provide additional authentication of the customer.

In one non-limiting example, an address may be checked against the current address found in a data file of customer account 408. In another non-limiting example, post active OCR processing may include checking a signature file within customer account 408 to verify the payee or payer signatures. It is also contemplated that a third party database can be checked for funds and signatures for checks from payors not associated with the customer's bank. Additional known OCR post processing techniques may be substituted without departing from the scope of the technology described herein.

Remote deposit platform 410 receives the extracted data fields of the check from the client device 302. In one non-limiting example, single identifiable data fields, such as the check field 206, date field 208, payee field 210, amount field 212, etc., are sequentially extracted from sequential confidence scored images 402 (e.g., highest score to lowest score) as communicated by the active OCR system 310 in real-time as they are detected and OCR processed. For example the MICR line 220 that includes a string of characters including the bank routing number and the customer's account number, may be processed before other data fields using a highest confidence scored image, or partial image, to immediately initiate a verification of the customer, while the active OCR processes the remaining fields on one or more additional confidence scored images, or partial images. In another non-limiting example, the amount fields may be processed to initiate a funds availability process before the remaining data fields have been extracted. Alternatively, or in addition to, the active OCR process may have a time ordered sequence of fields to be processed. Alternatively, or in addition to, all identifiable check fields are processed simultaneously in parallel by the active OCR system 310 across multiple confidence scored images, or partial images.

Active OCR system 310 communicates one or more data fields extracted in the OCR operation to a funds availability model 412. For example, active OCR 310 communicates customer data (e.g., name, address, account number, bank information (e.g., routing information), check number, check amount (e.g., funding amount needed), authorization and anti-fraud information (e.g., signature verifications, watermark or other check security imagery), etc. Funds availability model 412 may return a fixed or dynamically modifiable funds availability schedule to the UI 306 on the client device 302.

Client device 302 may also obtain a check image using a camera 104. The check images, including the front and back of the check, are transmitted along with the active OCR data. The check images can then be stored in the customer account 408 for later use if necessary. However, the processing of the active OCR data is independent of the check images taken by the camera 104. In other words, the check deposit can be completed without processing the check images.

Remote deposit platform 410 computes a funds availability schedule based on one or more of the received data fields, customer history received from the customer's account 408, bank funding policies, legal requirements (e.g., state or federally mandated limits and reporting requirements, etc.), or typical schedules stored within funds availability platform 412, to name a few. For example, the active OCR system 310 identifies the MICR data as a verified data field that may be used to access a customer's account 408. This access allows the bank identified in the MICR to provide a history of the customer's account 408 to the Remote deposit platform 410. Early access to the customer's account or account information may also provide a verified customer for security purposes to eliminate or reduce fraud early in the remote deposit process. Accordingly, enhancing early fraud detection is a technical improvement of the disclosed technology over existing systems.

Remote deposit platform 410 communicates a remote deposit status 414 to the customer's device. For example, the acceptance of the active OCR processed data is communicated. Alternatively, a request to continue pointing the camera at one or more sides of the check is communicated to and rendered as on-screen instructions on the client device 302, within one or more user interfaces (UIs) of the customer device's mobile banking app 304. The rendering may include imagery, text, or a link to additional content. The UI may instantiate the remote deposit status 414 as images, graphics, audio, etc. In another technical improvement over existing systems, the remote deposit status is provided mid-stream, prior to completion of the deposit. In this approach, the customer may terminate the process prior to completion if they are dissatisfied with the remote deposit status 414 or if they identify that an error has occurred.

In one embodiment, remote deposit platform 410 tracks customer behavior. For example, it can assess whether the customer completes a remote deposit operation or cancels the request. In some aspects, the completion of the remote deposit operation reflects a successful outcome, while a cancellation reflects a failed outcome. In some aspects, this customer behavior, not limited to success/failure, may be fed back to a ML system 339 within the remote deposit platform 410 to enhance future training of a ML OCR model (e.g., active OCR model) or remote deposit models. For example, in some embodiments, one or more inputs to the ML funding models may be weighted differently (higher or lower) to effect a predicted higher successful outcome.

Alternatively, or in addition to, one or more components of the remote deposit flow may be implemented within the customer device, third party platforms, a cloud-based system, distributed across multiple computer-based systems, or combinations thereof.

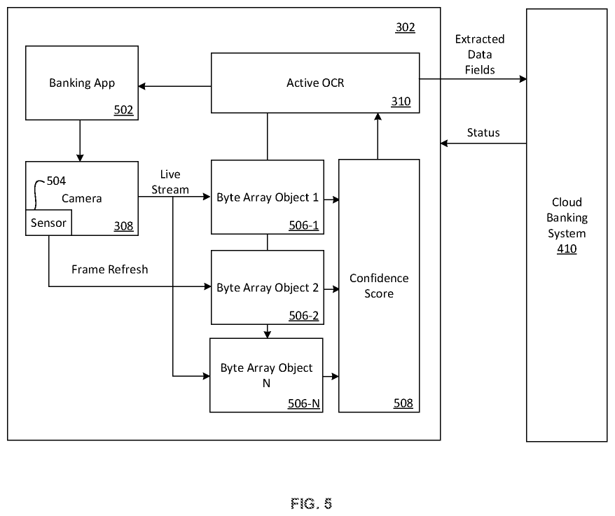

FIG. 5 illustrates an example diagram of a client device 302, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In one embodiment, banking app 502 is opened on the client device 302 and the deposit check function selected to initiate a remote deposit process. A camera 308 is activated to initiate a live stream of imagery from a field of view of the camera 308. The camera may output, for display on user interface (UI) 306 (shown in FIG. 3), a frame (e.g., an image frame or a frame of a video, for example) having one or more images (e.g., images of real-world objects) that are viewable by camera 308. An image frame may include one or more real-world objects. For instance, an image may represent an entire group of checks in a field of view of camera 308, or the image may represent one or more individual objects within the group. In one aspect, the image, or partial images, of decodable check indicia can be provided by a raw image byte stream or by a byte array, a compressed image byte stream or byte array, and/or a partial compressed image byte stream or byte array.

The raw image stream may be detected by an active-pixel sensor (such as a complementary metal-oxide-semiconductor (CMOS) image sensor or a charge-coupled device (CCD). In CCDs, there is a photoactive region (an epitaxial layer of silicon), and a transmission region made out of a shift register. An image is first projected through a lens onto the photoactive region of the CCD, causing each capacitor of a capacitor array to accumulate an electric charge proportional to the light intensity at that location. A one-dimensional array, used in line-scan cameras, captures a single slice of the image, whereas a two-dimensional array, used in video and still cameras, captures a two-dimensional picture corresponding to the scene projected onto the focal plane of the sensor. Once the array has been exposed to the image, a control circuit causes each capacitor to transfer its contents to its neighbor (operating as a shift register). The last capacitor in the array dumps its charge into a charge amplifier, which converts the charge into a voltage. By repeating this process, the controlling circuit converts the entire contents of the array in the semiconductor to a sequence of voltages. These voltages are then sampled, digitized, and may be stored in computer memory within client device 302, such as image memory 312.

In a non-limiting example, the live streamed image data may be assembled into one or more byte array objects 506 (1-N), such as frames, or partial frames, of image content. In one aspect, a data signal from a sensor 504 (e.g., CMOS or CCD) on camera 308 notifies the banking app when an entire sensor has been read out as streamed data. In this approach, the camera sensor is cleared of electrons before a subsequent exposure to light and a next frame of an image captured. This clearing function or frame refresh may be conveyed to the banking app 502, or the active OCR system 310, to indicate that the Byte Array Output Stream object constitutes a complete frame of image data. In some aspects, the images formed into a byte array object may be first rectified to correct for distortions based on an angle of incidence, may be rotated to align the imagery, may be filtered to remove obstructions or reflections, and may be resized to correct for size distortions using known image processing techniques. In one aspect, these corrections may be based on recognition of corners or borders of the check as a basis for image orientation and size, as is known in the art.

In one example, a series of byte array objects 506 (1-N) are formed as sequential sensor frame refresh signals are received. As each byte array object is formed, it may be processed, as previously described, by the ML trained confidence models 508 to determine an overall confidence score, where confidence may be based on quality of one or more portions of the byte array object. The determined confidence scores may be ranked (highest to lowest) by the banking app as the byte array objects 506 (1-N) are instantiated, with active re-ranking as new byte array object scores are calculated, or may be ranked after the active OCR system receives a selected number, for example, ten confidence scores. Alternatively, the active OCR system 310 may provide the ranking function.

While any portion of a byte array may be OCR processed during data field captures, in some embodiments, a Byte Array Output Stream object 506 (1-N) of an entire frame, or multiple frames, may be OCR processed sequentially until all data fields have been extracted. For example, multiple images or multiple image portions may be processed to collectively overcome low quality image captures, such as, but not limited to those images that are missing pixels, that include shadowing, that are taken from sharp angles, or that are off-centered, to name a few. In a non-limiting example, a first image is scored as a high quality image, as 90% of the image overall has a high confidence score (e.g., 900). However, a right corner of this image is missing. A second image of equal to or lower quality may be subsequently OCR processed to capture any data fields that may be located in the missing corner. The technology described herein extracts as many fields from the best image or image portion and continues the extraction process sequentially on a next highest quality image or image portion, processing as many images or image portions, until all data fields have been extracted. Continuing from the above example, if only a lower right corner of an image is missing, a byte array substantially formed from pixels originating from the lower right corner of the check image may be OCR processed to capture the missing data field(s) using any of the techniques disclosed herein. Corner and position designations may be generated based on the recognition of check border or edges.

For example, five data fields may be extracted from a first highest confidence scored Byte Array Output Stream object, while the remaining data fields may be extracted from one or more subsequent lower scored Byte Array Output Stream objects. This extracted data may be continuously transmitted, periodically transmitted or be transmitted after completion of the active OCR process (e.g., after all data fields are extracted), as check data fields to a cloud banking system 316 via a network connection.

In one aspect, the front side imagery is processed followed by the back side imagery. Alternatively, or in combination, the front side and back side imagery is processed together or in parallel.

In some embodiments, the remote deposit platform 410, as previously described in FIG. 4, may be used to assist implementation of the localized client device 302, OCR processing, or active OCR 310 processing. In a non-limiting example, computer vision algorithms for OCR processing may use large language models (LLM). A large language model is a language model characterized by emergent properties enabled by its large size. As language models, they work by taking an input text and repeatedly predicting the next token or word. They may be built with artificial neural networks, pre-trained using self-supervised learning and semi-supervised learning, typically containing tens of millions to billions of weights. In some aspects, LLM includes Natural Language Processing (NLP). One goal is a computer capable of “understanding” the contents of images, including the contextual nuances of the language within them. The technology can then accurately extract information and insights contained in the images as well as categorize and organize the images or fields within images themselves. LLM and NLP functionality may be implemented on the remote deposit platform 410 to train and improve the previously described ML OCR models that may be operative with the mobile device for the localized active OCR processing.

The technical solution disclosed above allows OCR or active OCR processing of highest quality live imagery, as scored by the ML trained confidence models, without first requiring communication of an image capture to a remote OCR processing system. This solution improves the quality of the OCR process, accelerates the remote check deposit process, and allows mid-stream alterations or improvements, for example, real-time image quality guidance or customer inputs (e.g., mid-stream cancelation), as well as the other technical advantages described throughout this disclosure.

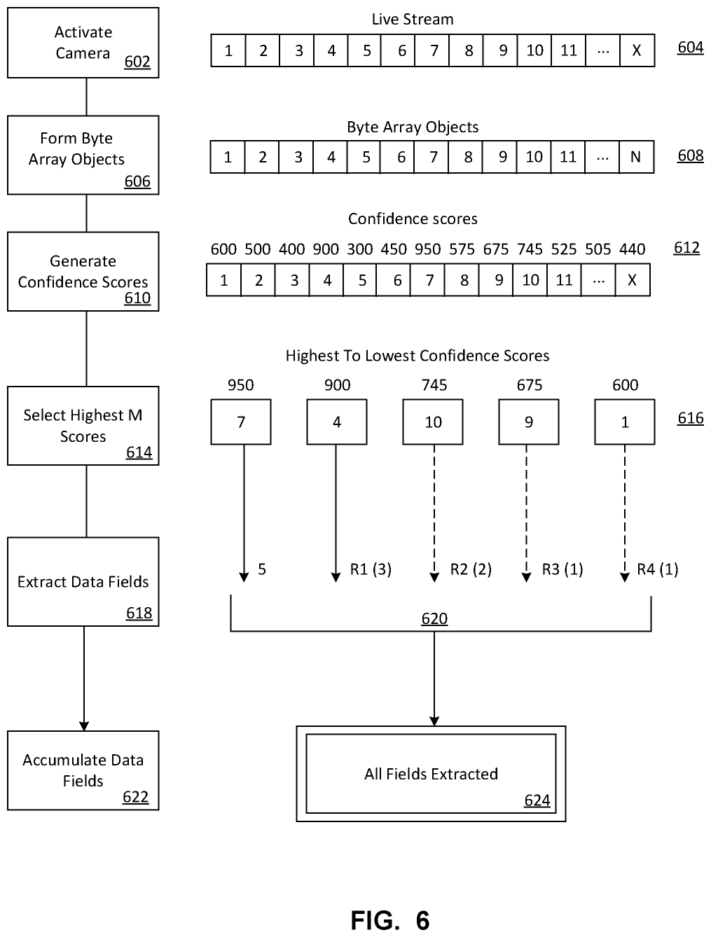

FIG. 6 is a flow chart 600 depicting a multiple image OCR or active OCR process for a remote check deposit that can be carried out in line with the discussion above. One or more of the operations in the method depicted by FIG. 6 may be carried out by one or more entities, including, without limitation, client device 302, cloud banking system 316, remote deposit platform 410, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some aspects, the systems described generate and instantiate an active OCR process for a ranked sequence of confidence scored images in a remote deposit environment.

In 602, a mobile banking app 302 instantiates a remote deposit by activating a client device 302 camera. For example, a customer using a mobile computing device, operating a mobile banking app, initiates a remote deposit by selecting this option on a UI of the banking mobile app on their mobile computing device. This selection provides instructions to the camera to communicate image data from the field of view of the camera as a live stream of image data 1-X, where X is a number of pixels of image data.

In 606, the raw live image stream 604, for example, pixels 1-X, is converted to byte array objects 608 (1-N), consistent with previously described byte array objects 506 (1-N). In one aspect, the live stream of image data may be continuously formed into byte array objects until an active OCR process has extracted selected data fields from the imagery of a check. Alternatively, the live stream of image data may be continuously formed into byte array objects until an active OCR process has extracted all data fields from the imagery of a check.

In 610, the multiple image active OCR process generates 610 a confidence score 612 for each byte array object received or for a selected number of byte array objects. In a first non-limiting example, by first detecting pixels that contain typed or written image components, with, for example, darker, higher contrast and common black or blue color values, a confidence score may be calculated based on an overall perceived individual image quality. In some aspects, the confidence score may be predicted by a trained ML model trained on previous images, assigned confidence scores, and corresponding quality ratings. Alternatively, or in addition to, in one aspect, a total pixel score for each image may be calculated.

As shown, byte array object 1 has a confidence score of 600 (e.g., out of 1000) based on a count of pixels with a pixel integer value below a selectable quality threshold (e.g., 50), where black has a score of 0 and a score of 50 is lighter shade of grey (e.g., darkest to lightest). While described for an integer value below 50, any pixel value number or range may be selected without departing from the scope of the technology described herein. For example, in some aspects, only pixels in a range of pixel values (e.g., range of known marking pixel values) may be processed, without processing the remaining pixels. For example, those pixels that only include a high pixel value (i.e., lighter pixel grey values), such as, a background color of the check may not be included in a generated confidence score. In some aspects, pixels that capture preprinted border pixels also may not be considered in the confidence score. In this aspect, the previously discussed ML models may be trained to recognize the values that represent the written or typed information as well as the preprinted borders. For example, using machine learning, thousands or millions of images may be processed to learn to accurately recognize and categorize these pixels.

Alternatively, or in addition to, segments or blocks within known data field areas on the check may be processed. Using supervised learning, thousands or millions of images may be processed to learn to recognize a check type and common data field locations relative to a border of the check. Alternatively, or in addition to, the two methods described above may be combined.

In 614, the multiple image active OCR process selects a number M of highest confidence scores 616, where M is an integer. In some aspects, the number of selections M may be predicted by a trained ML model trained on previous scored byte array objects. For example, a ML image model may be trained to recognize an optimum number of image frames, or portions of frames, to be selected, optimum confidence scores (e.g., discard images below a selected confidence score), or combinations of confidence scores that will produce a multiple image active OCR process meeting or exceeding an OCR extraction success rate. For example, the model determines that additional byte array objects, over a selected confidence value, are needed to combine to meet a selected success rate. In this example, the camera would remain active until the targeted extractions are available. For example, for low light environments, a higher number of byte array objects may need to be selected for a multiple image active OCR process. In some aspects, the process may fail if the targeted extractions are not available, or available within a selected time frame. Under these failure conditions, the image object building and extraction processes may be terminated and the user may be notified. For example, under extremely low light, the process may not produce enough quality images to complete the extraction process for the targeted data fields and the user may receive an error message or other notification.

In other aspects, the number M of byte array object selections may be based on any of, a preset number, a percentage of the total number of byte array objects in the set, or only based on those byte array objects above a selectable confidence score, to name a few. As shown, example byte array objects 7, 4, 10, 9 and 1 have the highest confidence scores of 950, 900, 745, 675 and 600, respectively.

In 618, the multiple image active OCR process processes the selected number M of highest scored byte array objects to extract a number of data fields 620 (e.g., set of targeted data fields). As shown, data fields may be extracted from the highest scored image object (e.g., 7), with a balance or remainder (R1) of target data fields extracted from the next highest scored image object (e.g., 4). In one aspect, a maximum possible number of data fields or remaining data fields are extracted from each sequentially scored image object. In an alternate extraction process, data fields are extracted from a plurality of image objects in parallel to increase extraction speeds.

In this example, if the complete set of targeted data fields are extracted from the first two highest scored images (7 and 4), the process is terminated and no additional extractions are needed from image objects 10, 9 and 1. However, if the extraction process from image objects 7 and 4 does not complete the set of targeted data fields, the remaining number of data fields (e.g., R2, R3, R4) may be extracted from each sequential image object. In one aspect, if the original X images selected do not result in the extraction of the set of targeted data fields, additional image objects may be selected for extracting any remaining data fields based on their respective confidence score-highest to lowest. In this example, five data fields were extracted from the highest confidence scored byte array object 7, three data fields were extracted from the second highest confidence scored byte array object 4, two from byte array object 10 and one each from byte array objects 9 and 1. In each OCR process, a maximum number of data fields are extracted from each of the highest ranked image objects until all the data fields have been extracted. The example number M of byte array objects used for an active OCR process is shown as five for simplicity purposes. However, the number of byte array objects is not limited and may be hundreds or even thousands of byte array objects until all desired data fields have been extracted. In addition, the byte array objects may include a full frame of data or be any portion of an image formed from the raw live image stream. For example, as an upper corner of an image is being formed into a byte array, it may be confidence scored and, if of a high enough score (e.g., above a threshold score) processed, in real-time, by the active OCR system 310 to extract any data fields located in this portion of the image. In a non-limiting example, as the customer moves their client device 302 around (e.g., standing over the check with at least a portion of the check in the field of view), a live image stream is being captured that can be formed into byte array objects, confidence scored, ranked, and active OCR processed.

This approach provides a technical solution to effectively extract data fields from the check imagery. For example, the user may move the client device around freely as the camera generates a live stream of potentially good (in-focus, good lighting, low shading, etc.) and bad quality imagery (e.g., shadows, glare, or off-center). The confidence scoring model will OCR only the highest quality streamed imagery without requiring the user to take a picture or communicate pictures to a remote OCR system, thus allowing for real-time extraction of the check data fields.

The images may be first rectified to correct for distortions based on an angle of incidence, or may be rotated to align the images, or may be filtered to remove obstructions or reflections and may be resized to allow same size image overlay configurations. In one aspect, these corrections may be based on recognition of corners or borders of the check.

While described throughout for active OCR processing, in some aspects, the OCR process may be any process that can extract data fields from the highest ranked data byte array objects, including remote systems and processes.

FIG. 7 illustrates a block diagram of a ML system, according to some embodiments and aspects. A multiple image active OCR implementation may include one or more system servers processing various banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art.

In some aspects, a multiple image active OCR model 710 may be processed locally on the client device 302 to improve check data field extraction performance, such as accuracy, quality and speed, to name a few. In various aspects, multiple image active OCR model 710 may be a standalone model or be integrated within mobile banking app 304 (as shown), or within active OCR system 310. Multiple image active OCR model may collectively implement any of, but is not limited to, a ML confidence model for scoring, a ML model for ranking confidence scores, a ML model for selecting an optimum number of ranked byte array objects, a ML model for communicating the selected byte array objects to an OCR process, and a ML model for determining when a target set of desired check data fields have been extracted.

Check imagery 704 (e.g., byte array objects) may be processed by the multiple image active OCR model 710 to predict formulations of optimum confidence scores, optimized check image selections, and optimum rankings of byte array objects that would achieve a quality threshold of check imagery for active OCR processing purposes.

Training of the multiple image active OCR model 710 may occur remotely from the client device 302 (e.g., in ML platform 329) and be communicated to the client device 302 as one or more ML trained model(s) 702 are trained and updated. Training may include exposing the ML models to hundreds, thousands, or more of historical images 726, where specific confidence scores, number of high confidence score selections, and success of data field extractions may be included in a supervised model build. Image quality thresholds 724 may be selectable and varied during the training process to generate an optimized threshold based on a historical correlation with active OCR extracted data fields. ML models 720 may each have varied metadata weightings, performance weightings, or quality weightings, but are not limited to these parameter weightings. One skilled in ML would appreciate that any of the parameters used in the active OCR extraction process, such as, but not limited to, image quality or performance targets may have weighting varied without departing from the scope of the technology disclosed herein.

Machine learning may involve computers learning from data provided so that they carry out certain tasks. For more advanced tasks, it can be challenging for a human to manually create the needed algorithms. This may be especially true of teaching approaches to correctly identify patterns. The discipline of machine learning therefore employs various approaches to teach computers to accomplish tasks where no fully satisfactory algorithm is available. In cases where vast numbers of potential answers exist, one approach, supervised learning, is to label some of the correct answers as valid or successful. For example, a high quality image may be correlated with a confidence score based on previously assigned quality ratings of a number of images. This may then be used as training data for the computer to improve the algorithm(s) it uses to determine future successful outcomes.

The predictive models 720 (e.g., 1-N) may classify customer's historical image data based on a positive result of OCR extracted data or by negative labels (e.g., low quality or missing extractions, etc.) against the trained predictive model to predict successful extractions and generate or enhance a previous generated model. In one embodiment, the ML models (e.g., models 720, 1-N) are continuously updated as new user financial interactions occur.

As shown, a series of desired models 720, 1-N, may be fed into the ML Engine 718 as predictor models to select a model that may result in optimized check data OCR extractions (e.g., amount, etc.). The model(s) 720 may be trained and continuously improved by analyzing relative success over a large data set, where success is measured by quality of OCR data field extractions. ML models 720 may be focused to generate queries for a specific performance level, for example an image quality threshold 724.

Images 704 received from the client device, including the byte object arrays used in the active OCR process, may be stored in the User Account DB 708. User Account DB 708 may also store user profile information that may be used with the remote deposit platform 410 to provide account and profile information based on associated identifiers (IDs). Additionally, as specific funds availability schedules 314 are presented to the user, for example, as rendered on their user device 302 through mobile banking app 304, the historical information may be added to the user's profile, and further be stored in the User Account DB 808.

Alternatively, or in addition to, one or more components of the ML platform 329 may be implemented within the user's mobile device, third party platforms, and a cloud-based system, or distributed across multiple computer-based systems.

The solutions described above improve the current remote deposits processes. The various aspects solve at least the technical problem that current systems do not OCR a high quality check image pre-deposit and/or require requesting additional images post check image processing. In addition, in some embodiments, the technical solution of processing a sequence of only the highest quality images, pre-deposit, reduces processing and memory requirements and therefore may improve remote deposit processing times and more efficiently utilize the limited system resources of a mobile device.

The various aspects solve at least the technical problems associated with performing OCR operations pre-deposit, without requiring communication of an image capture to a remote OCR system. The various embodiments and aspects described by the technology disclosed herein are able to provide active OCR operations and remote deposit status mid-experience, before the customer completes the deposit and without requiring the customer to provide additional new image captures post image quality or OCR failures.

### Example Computer System

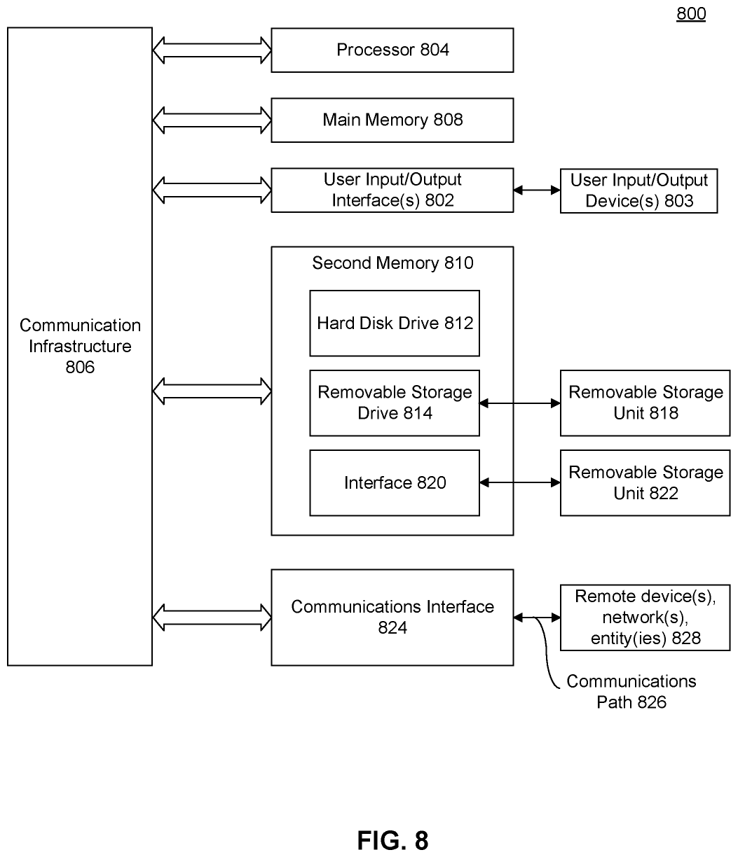

FIG. 8 depicts an example computer system useful for implementing various embodiments.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 800 may include one or more processors (also called central processing units, or CPUs), such as a processor 804. Processor 804 may be connected to a communication infrastructure or bus 806.

Computer system 800 may also include user input/output device(s) 802, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 816. Removable storage unit 816 may include a computer usable or readable storage device having stored thereon computer software (control logic) and/or data. Removable storage unit 816 may be a floppy disk, magnetic tape, compact disk, DVD, optical storage disk, and/any other computer data storage device. Removable storage drive 814 may read from and/or write to removable storage unit 816.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 816 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A computer-implemented method for remote deposit using a client device, comprising:
activating, on the client device, a remote deposit application;
activating, based on receiving a user request to initiate a remote deposit, a camera on the client device, wherein the camera provides access to a field of view of the camera;
capturing, by the camera, a live stream of at least partial images of a financial instrument;
forming a plurality of image objects from the live stream;
generating a confidence score for each of the plurality of image objects;
ranking individual image objects of the plurality of image objects from a highest to lowest confidence score;
performing, on the client device and starting with a highest ranked image, an optical character recognition (OCR) process on a number of sequentially ranked image objects to extract data fields, wherein a first set of data fields, less than a target set of data fields, are extracted, during a single instantiation of the OCR process, and wherein the performing the OCR process is repeated for each descending confidence scored image object of the number of sequentially ranked image objects until the target set of data fields has been extracted; and
communicating the extracted data fields to a remote deposit server.

2. The computer-implemented method of claim 1, wherein the forming a plurality of image objects from the live stream comprises configuring a plurality of pixels into a plurality of byte arrays.

3. The computer-implemented method of claim 1, wherein the byte array comprises a partial frame or an entire frame of the financial instrument.

4. The computer-implemented method of claim 1, wherein the number of sequentially ranked image objects is selected by a trained machine learning (ML) model.

5. (canceled)

6. (canceled)

7. The computer-implemented method of claim 1, wherein the confidence scoring is based on trained a machine learning (ML) model.

8. A system, comprising:
a memory; and
at least one processor coupled to the memory and configured to:
activate, on a mobile device, a remote deposit application;
activate, based on receiving a user request to initiate a remote deposit, a camera on the mobile device, wherein the camera provides access to a field of view of the camera;
capture, by the camera, a live stream of at least partial images of a financial instrument;
form a plurality of image objects from the live stream;
generate a confidence score for each of the plurality of image objects;
rank individual image objects of the plurality of image objects from a highest to lowest confidence score;
perform, on the mobile device starting with a highest ranked of the image objects, an optical character recognition (OCR) process on sequentially ranked image objects to extract data fields, wherein a first set of data fields, less than a target set of data fields, are extracted, during a single instantiation of the OCR process, and wherein the performing the OCR process is repeated for each descending confidence scored image object of the number of sequentially ranked image objects until the target set of data fields has been extracted; and
communicate the extracted data fields to a remote deposit server.

9. The system of claim 8, wherein the plurality of image objects of the financial instrument are derived from a stream of live camera imagery formed into a plurality byte arrays.

10. The system of claim 8, wherein the forming a plurality of image objects from the live stream comprises configuring a plurality of pixels into a byte array.

11. The system of claim 8, wherein the byte array comprises a partial frame or an entire frame of the financial instrument.

12. The system of claim 8, wherein a number of sequentially ranked image objects is selected by a trained machine learning (ML) model.

13. (canceled)

14. (canceled)

15. A non-transitory computer-readable device having instructions stored thereon that, when executed by a computing device, causes the at least one computing device to perform operations comprising:
activating, on the computing device, a remote deposit application;
activating, based on receiving a user request to initiate a remote deposit, a camera on the computing device, wherein the camera provides access to a field of view of the camera;
instructing the camera to capture a live stream of at least partial images of a financial instrument;
forming a plurality of image objects from the live stream;
generating a confidence score for each of the plurality of image objects;
ranking individual image objects of the plurality of image objects from a highest to lowest confidence score;
performing, on the computing device starting with a highest ranked image, an optical character recognition (OCR) process on sequentially ranked image objects to extract data fields, wherein a first set of data fields, less than a target set of data fields, are extracted, during a single instantiation of the OCR process, and wherein the performing the OCR process is repeated for each descending confidence scored image object of the number of sequentially ranked image objects until the target set of data fields has been extracted; and
communicating the extracted data fields to a remote deposit server.

16. The non-transitory computer-readable device of claim 15, wherein the plurality of image objects of the financial instrument are derived from a stream of live camera imagery formed into a plurality of byte arrays.

17. The non-transitory computer-readable device of claim 15, wherein the forming a plurality of image objects from the live stream comprises operations configuring a plurality of pixels into a byte array.

18. The non-transitory computer-readable device of claim 15, wherein the byte array comprises a partial frame or an entire frame of the financial instrument.

19. The non-transitory computer-readable device of claim 15, wherein the number of sequentially ranked image objects is selected by operations of a trained machine learning (ML) model.

20. (canceled)

21. A computer-implemented method using a client device, comprising:
activating, based on receiving a user request to initiate a remote document data field extraction process, a camera on the client device, wherein the camera provides access to a field of view of the camera;
capturing, by the camera, a live stream of at least partial images of a document;
forming a plurality of image objects from the live stream;
generating a confidence score for each of the plurality of image objects;
ranking individual image objects of the plurality of image objects from a highest to lowest confidence score;
performing, on the client device starting with a highest ranked of the image objects, an optical character recognition (OCR) process on sequentially ranked image objects to extract data fields, wherein a first set of data fields, less than a target set of data fields, are extracted, during a single instantiation of the OCR process, and wherein the performing the OCR process is repeated for each descending confidence scored image object of the number of sequentially ranked image objects until the target set of data fields has been extracted; and
communicating the extracted data fields to a remote server.
